(19) United States
(12) Patent Application Publication
(10) Pub. No.: US 2026/0290938 A1
(43) Pub. Date: Sep. 24, 2026

(54) BATTERY MODULE COMPRISING A COOLING CIRCUIT

(71) Applicant: SAFRAN ELECTRICAL & POWER, Blagnac Cedex (FR)

(72) Inventors: Frédéric PINARD, Moissy Cramayel (FR); Julien Giron, Moissy Cramayel (FR); Philippe Czech, Moissy Cramayel (FR)

(73) Assignee: SAFRAN ELECTRICAL & POWER, Blagnac Cedex (FR)

(21) Appl. No.: 19/689,273

(22) Filed: May 27, 2026

Related U.S. Application Data
(63) Continuation of application No. PCT/FR2024/051555, filed on Nov. 26, 2024.

(30) Foreign Application Priority Data
Nov. 27, 2023 (FR) 23/13092

(51) Int. Cl. H01M 10/6551; H01M 10/613; H01M 10/643; H01M 10/647; H01M 10/6568; H01M 50/211; H01M 50/213; H01M 50/51; H01M 50/512

(52) U.S. Cl. CPC H01M 10/6551; H01M 10/613; H01M 10/643; H01M 10/647; H01M 10/6568; H01M 50/211; H01M 50/213; H01M 50/51; H01M 50/512

(57) ABSTRACT

A battery module includes a cooling circuit having a cooling tube and a plurality of fins attached to the cooling tube. Each fin has a cooperation portion in contact with the cooling tube and the cooperation portion extends at least partially along a direction in which the cooling tube extends, so as to define a shape-fitting to the cooling tube. Each fin also has a plurality of electrochemical cells and each electrochemical cell includes two terminals. The electrochemical cells are configured to be connected together in series and/or in parallel, and each electrochemical cell is configured to be in contact with at least one fin or at least one element for connection to the fin.

### CROSS-REFERENCE TO RELATED APPLICATIONS

This application is a continuation of International Application No. PCT/FR2024/051555, filed on Nov. 26, 2024, which claims priority to and the benefit of French Application No. FR 23/13092 filed on Nov. 27, 2023. The disclosures of the above applications are incorporated herein by reference.

### FIELD

The present disclosure relates to a battery module, in one application for an aircraft.

### BACKGROUND

The statements in this section merely provide background information related to the present disclosure and may not constitute prior art.

Climate change is a concern for numerous legislative and regulatory bodies around the world. Various restrictions on carbon emissions have been, are being, or will be adopted by different countries. In particular, an ambitious standard applies both to new types of aircraft and to those currently in service, thus resulting in the implementation of technological solutions in order to render them compliant with applicable regulations. Civil aviation has been mobilizing for several years to contribute to the fight against the climate change.

Technological research efforts have already made it possible to significantly improve the environmental performance of aircraft. Factors impacting phases of design and development are taken into consideration in order to obtain aeronautical components and products that consume less energy, are more environmentally friendly, and whose integration and use in civil aviation have moderate environmental impacts, with the aim of improving aircraft energy efficiency. Consequently, work to reduce the climate impact has been undertaken by employing methods and implementing development and manufacturing methods that are environmentally sound and reduce greenhouse gas emissions as much as possible, in order to reduce the environmental footprint.

These sustained research and development efforts notably relate to the development of onboard electrical technologies, for example to provide propulsion.

An electric battery module comprises a plurality of electrochemical cells, each provided with at least two terminals. The electrochemical cells can thus be connected together in series and/or in parallel.

It is known to use several types of electrochemical cells, each having different geometric characteristics.

A pouch-type electrochemical cell comprises an outer casing comprising a laminated metal film. This type of electrochemical cell is lightweight and simple to manufacture but must be held in position due to its flexible structure.

A cylindrical electrochemical cell, in one form, is rigid, which allows mounting, permitting fewer retaining reinforcements. A drawback of this type of cell lies in its cylindrical shape, which leaves empty spaces within the battery module.

A rigid prismatic-format electrochemical cell comprises an outer casing forming a rectangular parallelepiped. This format offers a very good packing factor but still has retaining reinforcements.

In addition to the constraints relating to the arrangement of the electrochemical cells within the battery module the electrochemical cells should be cooled during operation for use in an aircraft.

Indeed, beyond a temperature threshold referred to as “thermal runaway,” which may be comprised between 70° C. and 110° C., internal exothermic chemical reactions may be initiated. When the accumulator is no longer capable of sufficiently dissipating heat, the temperature of the cell increases until destruction. This phenomenon is commonly referred to as thermal runaway. In other words, thermal runaway occurs in a battery when the energy released by the exothermic reactions occurring within it exceeds the capacity to dissipate it to the outside.

Document FR3131454 A1 describes, for example, metallic cooling tubes welded to a support plate. The support plate, together with a cover, forms a closed mechanical housing configured to confine the heat produced by the electrochemical cells, the cooling tubes removing heat to regulate the temperature.

However, a difficulty is observed in cooling the electrochemical cells, as the contact between the latter and the support plate is limited. This results in a reduced heat flow.

There are other systems in which coils carrying a cooling fluid are inserted directly between the cells (for example cylindrical cells) and are thus placed in direct contact with the cells. However, such a cooling circuit has a significant impact in terms of bulk and weight.

The present disclosure addresses the above-mentioned drawbacks.

### SUMMARY

This section provides a general summary of the disclosure and is not a comprehensive disclosure of its full scope or all of its features.

The present disclosure provides a battery module comprising a cooling circuit and a plurality of electrochemical cells. The cooling circuit includes at least one cooling tube and a plurality of fins attached to the cooling tube. Each fin has a cooperating portion in contact with the cooling tube. The cooperating portion extends at least partly along an extension direction of the cooling tube so as to define a cooperation by shape complementarity between the fin and the cooling tube. The plurality of electrochemical cells each comprising two terminals. The electrochemical cells are configured to be connected together in series and/or in parallel. Each electrochemical cell is configured to be in contact with at least one fin or at least one connecting element to the fin.

The cooperation between the cooling tube and the fins, in one form, and between the fins and the electrochemical cells, in another form, provides an effective thermal link between a heat source (the electrochemical cells when they must dissipate heat) and a cold source (the cooling tube).

This arrangement thus provides efficient removal of heat from the battery module. Due to the good thermal transfer efficiency, the size of the cooling tube and the flow rate used may be reduced.

The electrochemical cells used may be of the Ni-Cd (Nickel-Cadmium) type. They may also be lithium-ion electrochemical cells comprising a metal oxide pair, such as Nickel and Cobalt-Graphite.

According to one aspect of the present disclosure, the fins and the cooling tube are made of aluminum or of a material having similar thermal conductivity properties.

According to one aspect of the present disclosure, the cooperating portion corresponds to a cylinder portion or to a cylinder extending at least partly along the extension direction of the cooling tube. The cylinder portion is for example coaxial with the cooling tube.

In the present disclosure, “cylinder portion” means the cooperating portion is a profile having a base in the form of a circular arc. In general, the cooperating portion has a small thickness relative to its extension surface.

The cooperating portion thus has an internal contact surface complementary in shape to an external surface of the cooling tube. This shape complementarity provides good heat transfer between the cooling tube and the fins.

According to one aspect of the present disclosure, the cooperating portion is crimped onto the cooling tube. The corresponding fin is secured to the cooling tube.

This arrangement improves the cooperation by complimentary shapes, the fins being press-fitted onto the cooling tube so as to be secured to the cooling tube.

Furthermore, this arrangement provides mechanical rigidity to the assembly formed by the cooling tube and the plurality of fins.

According to one aspect of the present disclosure, the consecutive fins are configured to be retained in position, along the extension direction of the cooling tube, at least one electrochemical cell or at least one electrochemical cell and at least one corresponding connecting element disposed between the consecutive fins.

It appears that two consecutive fins also serve as positioning elements in addition to their function as heat transfer elements. Between two consecutive fins, one or more electrochemical cells may thus be provided, in one form, together with one or more connecting elements (such as thermal drains). This arrangement makes it possible to stiffen the battery module. Thus, it is easier to handle and the electrochemical cells maintain their positions relative to the fins. The battery module is consequently more robust and easier to assemble as a standalone unit.

According to one aspect of the present disclosure, the electrochemical cells are of the pouch type. Each electrochemical cell extends along a respective main plane transverse to the extension direction of the cooling tube.

Each respective main plane is parallel to the adjacent fin. Thus, the battery module is in the form of a stack of layers. Each layer extends transversely to the extension direction of the cooling tube. The advantage of the arrangement of the battery module is that it forms a rigid assembly even though the electrochemical cells are flexible.

According to another aspect, each fin extends along a fin plane transverse to the extension direction of the cooling tube. Each fin is parallel to the electrochemical cells.

According to another form, the electrochemical cells are of the cylindrical type. In this case, the consecutive fins are configured to be retained in position, along the extension direction of the cooling tube, several electrochemical cells, in one form, with one or more connecting elements disposed between the consecutive fins.

According to one example, it is possible to arrange between five and twenty-five, in particular fifteen, electrochemical cells between two consecutive fins. The cylindrical electrochemical cells each have an axis of revolution extending parallel to the extension planes of the consecutive fins.

Each cylindrical electrochemical cell has two opposite ends forming the terminals of the electrochemical cell. The cylindrical electrochemical cells are arranged in rows and columns so as to define rows in which the electrochemical cells are secured together via their ends. This arrangement makes it possible to place several electrochemical cells between two consecutive fins. The electrochemical cells of the same row being connected in series. One or more connecting elements may be used to fill the empty spaces left between the electrochemical cells and the fins.

According to another form, each electrochemical cell is of rigid prismatic format. In this case, the construction is similar to that of pouch-type electrochemical cells. The thickness of this rigid prismatic format is greater than that of a pouch cell. The thickness being the dimension along the extension axis of the cooling tube. The construction remains the same and one or more connecting elements may be added between the electrochemical cell and the adjacent fin.

According to one aspect of the present disclosure, the connecting element is a layer disposed between the electrochemical cell and the adjacent fin. The connecting element is made of a thermally conductive material and/or of a material capable of deforming so as to absorb mechanical stresses transmitted by the electrochemical cell and/or the adjacent fin. The connecting element thus makes it possible to adapt the fins to the electrochemical cells even if there is no perfect shape complementarity between the latter. Depending on the selected mounting, the connecting element may have a protective or damping function, or a thermal conduction function in order to improve heat dissipation from the electrochemical cells to the fins.

According to one form, the connecting element is a thermal drain adapted to be attached to an electrochemical cell. The thermal drain is configured to conduct heat generated by the electrochemical cell to the fin. The thermal drain may comprise at least one tab folded at a right angle and configured to cooperate with a thickness of the electrochemical cell. In particular, the thermal drain is a graphite sheet on which an adhesive portion is applied, such as an aluminum adhesive tape.

According to another form, the connecting element is made of foam and arranged to be compressed under the effect of the electrochemical cell and/or the adjacent fin. The foam may be disposed on one side only of the electrochemical cell when it is made of a thermally insulating material. Thus, the heat from the electrochemical cell is directed toward the fin located on the other side. This arrangement may be useful for defining a heat dissipation path followed by the heat from the electrochemical cell toward the cooling tube.

In another form, a thermally conductive foam may be provided, which can be used on both sides of the electrochemical cell. Furthermore, the connecting element may be made of any other material having both damping and/or thermal conduction properties.

According to one aspect of the present disclosure, each fin comprises a body secured to the cooperating portion. The body extends along a height dimension and along a width dimension transverse to the height dimension. The body has a free portion extending beyond the adjacent electrochemical cell along the height dimension and/or the width dimension. This oversizing of the fin relative to the electrochemical cell promotes the heat dissipation by convection. Indeed, depending on the temperature differences, an airflow is generated, in particular along the width. In one form, the free portion extends along the height dimension. The fins may also be drilled into the free portion in order to add a structural component of the battery module. This improves mechanical rigidity.

According to one aspect of the present disclosure, at least one fin comprises a measurement pick-up portion attached to the body and extending along the width dimension and/or along the height dimension. The measurement pick-up portion is configured to be connected to a measuring device or to a connection element to a measuring device, such as a cable. The measuring device may be configured to measure a temperature. The measurement is thus accurate without being carried out in an intrusive manner. In one form, the measurement pick-up portion is an extension of the body formed integrally with the body.

According to one aspect of the present disclosure, the cooling circuit comprises at least two cooling tubes connected by at least one connecting tube of the cooling circuit, for example a bend, so as to form the cooling circuit with an inlet and an outlet.

In one form, the cooling circuit comprises two cooling tubes extending in parallel, the at least one connecting tube being a 180° bend. Each fin thus includes two cooperating portions, the cooling circuit forming a return path. The two cooling tubes are aligned along the width dimension.

Each cooperating portion is comprised in a protrusion of the body, in one form, having an oblong or circular arc shape extending along the height dimension.

The free portion is located opposite the at least one protrusion along the height dimension. The battery module thus dissipates heat via the cooling circuit at one end and by convection at another opposite end.

According to one aspect of the present disclosure, the terminals of each electrochemical cell extend beyond the fins along the width dimension. The terminals are thus easily accessible.

The present disclosure also provides a closed mechanical enclosure comprising a base and a cover arranged to cooperate with the base in a closed position. The closed mechanical enclosure comprises at least one battery module as described above. The at least one battery module is adapted to be arranged within the closed mechanical enclosure. The corresponding at least one cooling circuit is configured to be connected to a cooling fluid circulation circuit external to the closed mechanical enclosure.

Thus, while being protected by the base and the cover, the cooling circuit(s) can be connected to an external cold source. The base and the cover make it possible to inhibit thermal runaway of the battery by confining the produced heat.

In one form, the closed mechanical enclosure has, for at least two cooling tubes, an opening adapted for the passage of the corresponding cooling tube between the interior and the exterior of the closed mechanical enclosure.

Thus, one cooling tube is an inlet tube and another cooling tube is an outlet tube. There may also be multiple inlets and outlets.

According to one aspect of the present disclosure, the opening is formed in the base. The base has a receiving recess adapted to receive the at least one battery module. In one form, the receiving recess is adapted to cooperate with the protrusions of the fins so as to retain the at least one battery module in position.

According to one aspect of the present disclosure, the closed mechanical enclosure may comprise a vent configured to be placed in an open or closed position. This vent is configured to evacuate heat in the event of overheating and/or thermal runaway.

The closed mechanical enclosure comprises at least one voltage sensor and/or at least one temperature sensor. The closed mechanical enclosure comprises a connection assembly for the terminals of the electrochemical cells and a control and balancing board of the at least one battery module. These elements being able to be internal or external to the closed mechanical enclosure depending on the configurations.

The present disclosure also provides an aircraft comprising at least one battery module as described above or comprising at least one closed mechanical enclosure as described above. The aircraft further comprises the cooling fluid circulation circuit connected to a cold source of the aircraft.

The aircraft also comprises a propulsion assembly and an electrical distribution chain configured to connect the propulsion assembly and the at least one closed mechanical enclosure to at least one current-consuming element of the aircraft. The electrical distribution chain comprises converters adapted to the types of produced and consumed current.

The present disclosure further provides a method for manufacturing a battery module as described above, comprising the following steps: providing at least one cooling tube, a plurality of fins, and a plurality of electrochemical cells; mounting a fin on the at least one cooling tube by fitting, then placing at least one electrochemical cell on the fin, or placing at least one electrochemical cell with at least one connecting element on the fin, then repeating the operation so as to form an alternation of fins and one or more electrochemical cells or one or more electrochemical cells with at least one connecting element.

The mounting of the battery module is improved. The fin is configured to cooperate with the tube so as to remain in place once mounted.

The alternation between fins and electrochemical cells (in one form accompanied by connecting elements such as thermal drains) makes it possible to form a rigid and robust assembly. This rigid assembly may comprise pouch-type, cylindrical, or prismatic-format electrochemical cells.

This manufacturing method makes it possible to obtain a battery module of reduced mass. Furthermore, industrialization is simplified with a straightforward mounting process.

According to one aspect of the present disclosure, the mounting of a fin on the at least one cooling tube is carried out by crimping so as to secure the fin to the at least one cooling tube.

The crimping also produces the cooperating portion by deformation of the fin. In one form, each fin is initially provided with an orifice having a diameter smaller than the outer diameter of the cooling tube. The fin is force-fitted onto the cooling tube and then moved by sliding to its final position by a dedicated tooling adapted for carrying out the crimping.

This manufacturing method is fast and reliable. The attachment of the fin to the cooling tube may be supplemented by welding.

The various aspects defined above, insofar as they are not incompatible, may be combined.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of a battery module in accordance with the principles of the present disclosure;

FIG. 2 is a detailed perspective view of the battery module of FIG. 1;

FIG. 3 is a perspective view of another battery module comprising cylindrical electrochemical cells;

FIG. 4 is a perspective view of an electrochemical cell and a connecting element attached to the electrochemical cell;

FIG. 5 is a perspective view of another battery module with a fin comprising two measurement pick-up portions;

FIG. 6 is a perspective view of the battery module of FIG. 1 with fins comprising free portions extending beyond the electrochemical cells;

FIG. 7 is an exploded perspective view of a closed mechanical enclosure comprising a battery module of FIG. 1; and

FIG. 8 is a diagram of current production and consumption in an aircraft.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the detailed description of the figures defined above, the same elements or elements performing identical functions may retain the same reference numerals in order to simplify the understanding of the present disclosure.

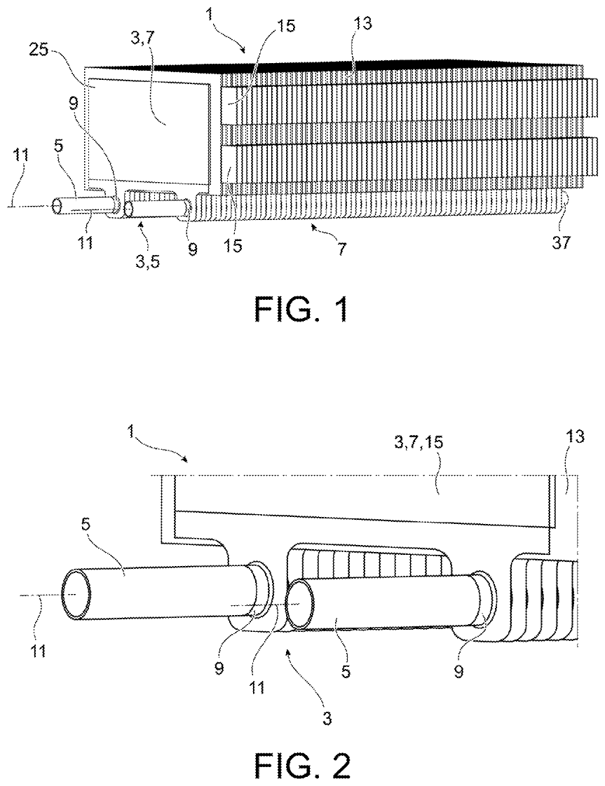

As illustrated in FIGS. 1 and 2, a battery module 1 comprises a cooling circuit 3 including two cooling tubes 5 and a plurality of fins 7 attached to the cooling tubes 5.

Each fin 7 has a cooperating portion 9 in contact with the corresponding cooling tube 5, the cooperating portion 9 extending at least partly along an extension direction 11 of the cooling tube 5 so as to define a cooperation by shape complementarity between the fin 7 and the cooling tube 5.

The battery module 1 comprises a plurality of electrochemical cells 13, each comprising two terminals 15. The electrochemical cells 13 are configured to be connected together in series and/or in parallel.

Each electrochemical cell 13 is configured to be in contact with at least one fin 7 or at least one connecting element 17 to the fin 7 (FIG. 4).

The electrochemical cells 13 used may be of the Ni-Cd (Nickel-Cadmium) type. They may also be lithium-ion electrochemical cells 13 comprising a metal oxide pair such as Nickel and Cobalt-Graphite. Any other chemical type may also be used, for example lithium-metal.

The fins 7 and/or the cooling tubes 5 are made of aluminum or of a material having similar thermal conductivity properties.

The cooperating portion 9 corresponds, for example, to a cylinder portion or to a cylinder extending at least partly along the extension direction 11 of the cooling tube 5.

In the present disclosure, “cylinder portion” means the cooperating portion 9 including a profile having a base in the form of a circular arc. In general, the cooperating portion 9 has a small thickness relative to its extension surface.

The cooperating portion 9 thus has an internal contact surface complementary in shape to an external surface of the corresponding cooling tube 5.

The cooperating portion 9 is in one form crimped onto the cooling tube 5. The corresponding fin 7 being secured to the cooling tube 5.

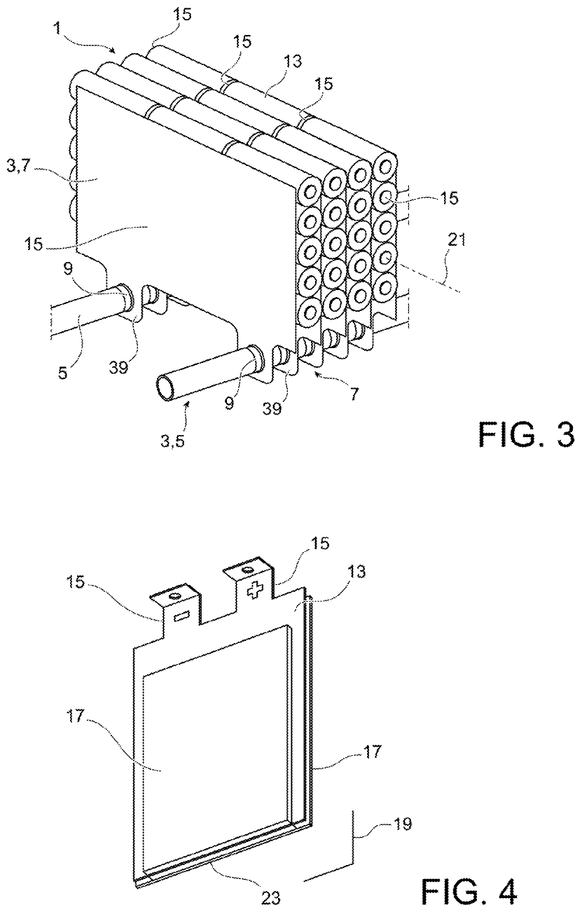

For example, the cooperating portion 9 is integrated at a protrusion 39 (FIG. 3) of the fin 7, in one form, having an oblong or circular arc shape projecting from the fin. The protrusion 39 may, for example, have a tab shape.

The consecutive fins 7 are configured to be retained in position, along the extension direction 11 of the cooling tube 5, at least one electrochemical cell 13 or at least one electrochemical cell 13 and at least one corresponding connecting element 17 disposed between the consecutive fins 7.

It appears that two consecutive fins 7 also serve as positioning elements in addition to their function as heat transfer elements. Between two consecutive fins 7, one or more electrochemical cells 13 may thus be provided, in one form, together with one or more connecting elements 17.

In one form, the electrochemical cells 13 are of the pouch type. Each electrochemical cell 13 extends along a respective main plane 19 transverse to the extension direction 11 of the cooling tube 5.

Each respective main plane 19 is parallel to the adjacent fin 7, and in particular to the plurality of fins 7, these being parallel to one another. Thus, the battery module 1 is in the form of a stack of layers with each layer extending transversely to the extension direction 11 of the cooling tube 5.

According to an alternative shown in FIG. 3, the electrochemical cells 13 are of the cylindrical type. In this case, the consecutive fins 7 are configured to be retained in position, along the extension direction 11 of the cooling tube 5, several electrochemical cells 13, in one form, with one or more connecting elements 17 disposed between the consecutive fins 7.

According to this example, it is possible to arrange between five and twenty-five, in particular fifteen, electrochemical cells 13 between two consecutive fins 7. The cylindrical electrochemical cells 13 each have an axis of revolution 21 extending parallel to the extension planes of the consecutive fins 7.

Each cylindrical electrochemical cell 13 has two opposite ends forming the terminals 15 of the electrochemical cell 13.

The cylindrical electrochemical cells 13 are arranged in rows and columns so as to define rows in which the electrochemical cells 13 are secured together via their ends.

This arrangement makes it possible to place several electrochemical cells 13 between two consecutive fins 7. The electrochemical cells 13 of the same row are connected in series.

In one form, one or more connecting elements 17 may be used to fill the empty spaces left between the electrochemical cells 13 and the fins 7.

As illustrated in FIG. 4, the connecting element 17 is a layer disposed between the electrochemical cell 13 and the adjacent fin 7. The connecting element 17 is made of a thermally conductive material and/or of a material capable of deforming so as to absorb mechanical stresses transmitted by the electrochemical cell 13 and/or the adjacent fin 7.

The connecting element 17 thus makes it possible to adapt the fins 7 to the electrochemical cells 13 even if there is no perfect shape complementarity between the latter.

Depending on the selected mounting, the connecting element 17 may serve as a protective or damping function, or a thermal conduction function in order to improve the dissipation of heat from the electrochemical cells 13 to the fins 7.

According to one form, the connecting element 17 is a thermal drain configured to be attached to an electrochemical cell 13. The thermal drain is configured to conduct heat generated by the electrochemical cell 13 to the fin 7.

The thermal drain may comprise at least one tab 23 folded at a right angle and configured to cooperate with a thickness of the electrochemical cell 13.

In particular, the thermal drain is a graphite sheet on which an adhesive portion is applied, such as an aluminum adhesive tape.

According to another form, as an alternative or in combination with the graphite drain, the connecting element 17 is made of foam and arranged to be compressed under the effect of the electrochemical cell 13 and/or the adjacent fin 7.

The foam may be disposed on one side only of the electrochemical cell 13 when it is made of a thermally insulating material. Thus, the heat from the electrochemical cell 13 is directed toward the fin 7 located on the other side.

This arrangement may be useful for defining a heat dissipation path followed by the heat from the electrochemical cell 13 toward the cooling tube 5.

Alternatively, a thermally conductive foam may be provided, which can be used on both sides of the electrochemical cell 13.

Furthermore, the connecting element 17 may be made of any other material having both damping and/or thermal conduction properties.

As illustrated in FIG. 6, in one possible form, each fin 7 comprises a body 25 secured to the cooperating portion 9. The body 25 extends along a height dimension 27 and along a width dimension 29 transverse to the height dimension 27.

The body 25 has a free portion 31 extending beyond the adjacent electrochemical cell 13 along the height dimension 27.

This oversizing of the fin 7 relative to the electrochemical cell 13 promotes heat dissipation by convection. Indeed, depending on temperature differences, an airflow is generated (see arrows in FIG. 6), in particular along the width 29.

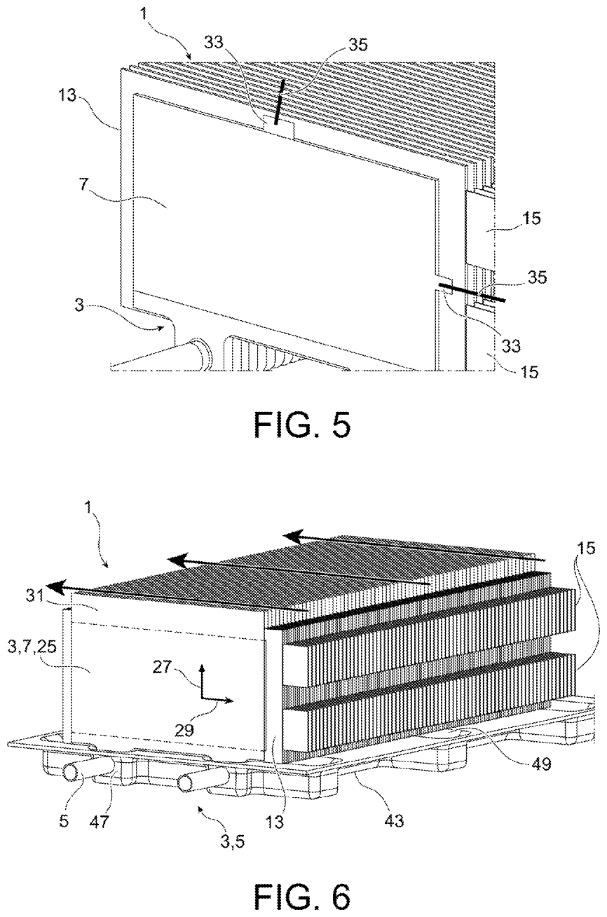

As illustrated in FIG. 5, at least one fin 7 comprises a measurement pick-up portion 33 attached to the body 25 and extending along the width dimension 29 and/or along the height dimension 27.

The measurement pick-up portion 33 is configured to be connected to a measuring device or to a connection element to a measuring device, such as a cable 35. The measuring device may be configured to measure a temperature. The measurement is thus accurate without being carried out in an intrusive manner.

In one form, the measurement pick-up portion 33 is an extension of the body 25 formed integrally with the body 25.

As illustrated in FIGS. 1-7, the cooling circuit 3 comprises two cooling tubes 5 connected by at least one connecting tube 37 of the cooling circuit 3, for example a bend, so as to form the cooling circuit 3 with an inlet and an outlet.

In one form, the cooling circuit 3 comprises two cooling tubes 5 extending in parallel. The at least one connecting tube 37 being a 180° bend.

Each fin 7 thus in one form includes two cooperating portions 9. The cooling circuit 3 forms a return path. The two cooling tubes 5 are aligned along the width dimension 29. The two cooling tubes in one form extend along two parallel directions.

Each cooperating portion 9 is comprised in a protrusion 39 of the body 25, in one form, having an oblong or circular arc shape extending along the height dimension 27.

The free portion 31 is located opposite the at least one protrusion 39 along the height dimension 27. The battery module 1 thus dissipates heat via the cooling circuit 3 at one end and by convection at another opposite end.

The terminals 15 of each electrochemical cell 13 extend beyond the fins 7 along the width dimension 29. The terminals 15 are thus easily accessible.

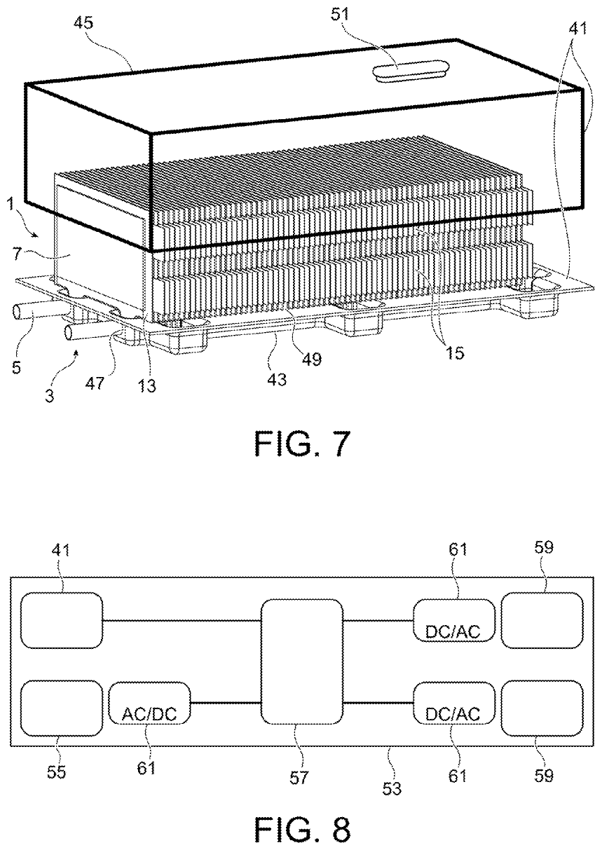

As illustrated in FIG. 7, a closed mechanical enclosure 41 comprises a base 43 and a cover 45 arranged to cooperate with the base 43 in a closed position.

The closed mechanical enclosure 41 comprises at least one battery module 1 as described above. The at least one battery module 1 being adapted to be arranged within the closed mechanical enclosure 41.

The at least one corresponding cooling circuit 3 is configured to be connected to a cooling fluid circulation circuit. The circulation circuit is, for example, external to the closed mechanical enclosure 41.

Thus, while being protected by the base 43 and the cover 45, the cooling circuit(s) 3 can be connected to an external cold source. The base 43 and the cover 45 make it possible to inhibit thermal runaway of the battery by confining the generated heat.

In one form, the closed mechanical enclosure 41 has, for at least two cooling tubes 5, an opening 47 adapted for the passage of the corresponding cooling tube 5 between the interior and the exterior of the closed mechanical enclosure 41.

Thus, one cooling tube 5 forms an inlet tube and another cooling tube 5 forms an outlet tube. There may also be multiple inlets and outlets.

The opening 47 is formed in the base 43. The base 43 has a receiving recess 49 configured to receive the at least one battery module 1. In one form, the receiving recess 49 is configured to cooperate with the protrusions 39 of the fins 7 so as to maintain the at least one battery module 1 in position.

The closed mechanical enclosure 41 may comprise a vent 51 configured to be placed in an open or closed position, allowing gases to be discharged, in particular in the event of a thermal runaway event.

The closed mechanical enclosure 41 comprises at least one voltage sensor and/or at least one temperature sensor. The closed mechanical enclosure 41 comprises a connection assembly for the terminals of the electrochemical cells 13 and a control and balancing board of the at least one battery module 1. These elements being able to be internal or external to the closed mechanical enclosure 41 depending on the configuration.

As illustrated in FIG. 8, an aircraft 53 comprises at least one closed mechanical enclosure 41 as described above. The aircraft 53 further comprises the cooling fluid circulation circuit connected to a cold source of the aircraft 53.

The aircraft 53 also comprises a propulsion assembly 55 and an electrical distribution chain 57 configured to connect the propulsion assembly 55 and the at least one closed mechanical enclosure 41 to at least one electrical load 59 of the aircraft 53. The electrical distribution chain 57 comprises converters 61 adapted to the types of produced and consumed current.

A method for manufacturing a battery module 1 as described above firstly comprises providing two cooling tubes 5, a plurality of fins 7, and a plurality of electrochemical cells 13.

The manufacturing method then comprises mounting a fin 7 on the cooling tubes 5 by fitting, then placing at least one electrochemical cell 13 or at least one electrochemical cell 13 with at least one connecting element 17 on the fin 7, and repeating the operation so as to form an alternation of fins 7 and one or more electrochemical cells 13 or one or more electrochemical cells 13 with at least one connecting element 17.

The alternation between fins 7 and electrochemical cells 13 makes it possible to form a rigid and robust assembly. This rigid assembly may comprise pouch-type, cylindrical-type, or prismatic-format electrochemical cells 13.

The mounting of a fin 7 on the cooling tube 5 is carried out by crimping so as to secure the fin 7 to the cooling tube 5.

The crimping in one form also forms the cooperating portion 9 by deformation of the fin 7. The mounting of the fin 7 on the cooling tube 5 by crimping secures the fin 7 and the cooling tube 5 by creating the cooperating portion 9.

In one form, each fin 7 is initially provided with an orifice having a diameter smaller than the outer diameter of the cooling tube 5. The fin 7 is force-fitted onto the cooling tube 5 and then moved by sliding to its final position using dedicated tooling adapted for crimping, thereby forming the cooperating portion 9. This manufacturing method is fast and reliable. The fastening of the fin 7 to the cooling tube 5 may be supplemented by welding.

In general, it appears that the cooperation between the cooling tubes 5 and the fins 7, in one form, and between the fins 7 and the electrochemical cells 13, in another form, provides an effective thermal link between a heat source (electrochemical cells 13) and a cold source (cooling tubes 5).

This arrangement thus provides an efficient heat dissipation from the battery module 1. Due to the high efficiency of heat transfer, the size of the cooling tube 5 and the flow rate used may be reduced.

The advantage of the arrangement of the battery module 1 is also to form a rigid assembly even though the electrochemical cells 13 are flexible.

The present disclosure is not limited to the single form described above by way of example, but encompasses all variant forms thereof.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery module comprising:
a cooling circuit comprising at least one cooling tube and a plurality of fins attached to the at least one cooling tube, each fin of the plurality of fins having a cooperating portion in contact with the at least one cooling tube, the cooperating portion extending at least partly along an extension direction of the at least one cooling tube so as to define a shape complementary to the at least one cooling tube, the cooperating portion being crimped onto the at least one cooling tube, the plurality of fins being secured to the at least one cooling tube; and
a plurality of electrochemical cells, each electrochemical cell of the plurality of electrochemical cells comprising two terminals, the plurality of electrochemical cells being configured to be connected together in series and/or in parallel, each electrochemical cell of the plurality of electrochemical cells being configured to be in contact with at least one fin of the plurality of fins or at least one connecting element associated with the at least one fin of the plurality of fins.

2. The battery module according to claim 1, wherein the cooperating portion corresponds to a cylinder portion or to a cylinder extending at least partly along the extension direction of the at least one cooling tube.

3. The battery module according to claim 2, wherein consecutive fins of the plurality of fins are configured to be retained in position, along the extension direction of the at least one cooling tube, and wherein at least one electrochemical cell of the plurality of electrochemical cells, or the at least one electrochemical cell of the plurality of electrochemical cells and the at least one connecting element are disposed between the consecutive fins.

4. The battery module according to claim 2, wherein the plurality of electrochemical cells are of a pouch type, and wherein each electrochemical cell of the plurality of electrochemical cells extends along a respective main plane transverse to the extension direction of the at least one cooling tube.

5. The battery module according to claim 2, wherein the at least one connecting element is a layer disposed between each electrochemical cell of the plurality of electrochemical cells and an adjacent fin, the at least one connecting element being made of a thermally conductive material and/or of a deformable material.

6. The battery module according to claim 1, wherein consecutive fins of the plurality of fins are configured to be retained in position, along the extension direction of the at least one cooling tube, and wherein at least one electrochemical cell of the plurality of electrochemical cells, or the at least one electrochemical cell of the plurality of electrochemical cells and the at least one connecting element are disposed between the consecutive fins.

7. The battery module according to claim 6, wherein the plurality of electrochemical cells are of a pouch type, and wherein each electrochemical cell of the plurality of electrochemical cells extends along a respective main plane transverse to the extension direction of the at least one cooling tube.

8. The battery module according to claim 6, wherein the at least one connecting element is a layer disposed between each electrochemical cell of the plurality of electrochemical cells and an adjacent fin, the at least one connecting element being made of a thermally conductive material and/or of a deformable material.

9. The battery module according to claim 1, wherein the plurality of electrochemical cells are of a pouch type, and wherein each electrochemical cell of the plurality of electrochemical cells extends along a respective main plane transverse to the extension direction of the at least one cooling tube.

10. The battery module according to claim 9, wherein each fin of the plurality of fins extends along a fin plane transverse to the extension direction of the at least one cooling tube, each fin of the plurality of fins being parallel to the plurality of electrochemical cells.

11. The battery module according to claim 9, wherein the at least one connecting element is a layer disposed between each electrochemical cell of the plurality of electrochemical cells and an adjacent fin, the at least one connecting element being made of a thermally conductive material and/or of a deformable material.

12. The battery module according to claim 1, wherein the at least one connecting element is a layer disposed between each electrochemical cell of the plurality of electrochemical cells and an adjacent fin, the at least one connecting element being made of a thermally conductive material and/or of a deformable material.

13. A closed mechanical enclosure comprising a base and a cover arranged to cooperate with the base in a closed position, the closed mechanical enclosure comprising at least one battery module according to claim 1, the at least one battery module being adapted to be arranged within the closed mechanical enclosure, the cooling circuit being configured to be connected to a cooling fluid circulation circuit external to the closed mechanical enclosure.

14. A method for manufacturing a battery module according to claim 1, the method comprising steps of:
(a) providing at least one cooling tube, a plurality of fins, and a plurality of electrochemical cells;
(b) mounting a fin of the plurality of fins on the at least one cooling tube by fitting, mounting of the fin of the plurality of fins on the at least one cooling tube being carried out by crimping so as to secure the fin of the plurality of fins to the at least one cooling tube;
(c) placing at least one electrochemical cell of the plurality of electrochemical cells on the fin of the plurality of fins or placing the at least one electrochemical cell of the plurality of electrochemical cells with at least one connecting element on the fin of the plurality of fins; and
(d) repeating steps (b) and (c) so as to form an alternation of the fin of the plurality of fins and the at least one electrochemical cell of the plurality of electrochemical cells, or an alternation of the fin of the plurality of fins and the at least one electrochemical cell of the plurality of electrochemical cells with the at least one connecting element.
